(19) United States
(12) Patent Application Publication
(10) Pub. No.: US 2022/0207361 A1
(43) Pub. Date: Jun. 30, 2022

(54) NEURAL NETWORK MODEL QUANTIZATION METHOD AND APPARATUS

(71) Applicant: SAMSUNG ELECTRONICS CO., LTD., Suwon-si (KR)

(72) Inventors: Jiali PANG, Xi'an (CN); Gang SUN, Xi'an (CN); Lin CHEN, Xi'an (CN); Zhen Zhang, Xi'an (CN)

(73) Assignee: SAMSUNG ELECTRONICS CO., LTD., Suwon-si (KR)

(21) Appl. No.: 17/552,501

(22) Filed: Dec. 16, 2021

(30) Foreign Application Priority Data
Dec. 25, 2020 (CN) 202011564315.0
Sep. 15, 2021 (KR) 10-2021-0122889

(51) Int. Cl. G06N 3/08

(52) U.S. Cl. CPC G06N 3/08

(57) ABSTRACT

A neural network model quantization method and apparatus is provided. The neural network model quantization method includes receiving a neural network model, calculating a quantization parameter corresponding to an operator of the neural network model to be quantized based on bisection approximation, and quantizing the operator to be quantized based on the quantization parameter and obtaining a neural network model having the quantized operator.

### CROSS-REFERENCE TO RELATED APPLICATION(S)

This application claims the benefit under 35 USC § 119(a) of Chinese Patent Application No. 202011564315.0 filed on Dec. 25, 2020, in the China National Intellectual Property Administration and Korean Patent Application No. 10-2021-0122889 filed on Sep. 15, 2021, in the Korean Intellectual Property Office, the entire disclosures of which are incorporated herein by reference for all purposes.

### BACKGROUND

### 1. Field

The following description relates to a neural network model quantization method and apparatus.

### 2. Description of Related Art

As neural network models have been widely implemented, the complexity of original neural network models has also increased and the execution of the neural network models in devices with limited memory capacity has become difficult. In a high-precision neural network model, the higher the ratio of some operators of a model to the total amount of parameters of an original model, the higher the frequency of use of the operators.

Thus, under the assumption that a loss of precision is small when all of these highly frequent operators are quantized from the form of an original floating-point number to the form of an integer and a subsequent operation is then performed, it is possible to significantly improve the memory occupancy and operation speed of a typical neural network model, and compress the size of the original model.

With regard to the quantization of a neural network model it may be beneficial to find a method that may greatly compress the memory space occupied by an original deep learning model and significantly improve the operation speed of the original model while minimizing a loss of accuracy in prediction of the original model. An input of the method may be an original high-precision floating-point depth model, and an output thereof may be a quantized low-precision integer model. This may have an important application prospect in practical applications. In implementing a quantified neural network model, it is possible to effectively complete a prediction task through an original neural network model in many small storage terminals.

However, typical quantization methods may not satisfy both aspects: the accuracy of a quantized neural network model and memory.

The typical quantization methods for depth models may mainly include a deterministic quantization method and a random quantization method. In an example, a typical quantization method based on a deterministic clipping function may complete model quantization by converting a continuous value (e.g., a high-precision floating-point number) into a discrete value (e.g., a low-precision integer) mainly using the clipping function. A typical method of setting the clipping function may include setting in advance the clipping function based on a global data distribution, using a maximum value as a clipping value, or using a clipping parameter determined based on a cross entropy theory in more examples. However, in implementing the typical method, when quantization is performed using the maximum value as the clipping value, the accuracy may be greatly degraded, and a quantized model may need to be trained to increase the accuracy. Additionally, determining the clipping parameter based on the cross entropy theory may have relatively high accuracy only when the distribution is symmetric and uniform, and the accuracy may be greatly degraded after quantization.

A typical vectorization-based method may cluster original high-precision operators into subgroups and perform quantization based on the subgroups. This vectorization method may mainly use a clustering method based on K-means. This vectorization method may have strong operability, but may perform quantization only in a model in which a pre-learned clipping function is defined. Thus, the typical vectorization-based method may not be effective in terms of universality.

A typical random quantization method may be largely divided into a random clipping-based quantization method and a probability distribution-based quantization method. The random clipping-based quantization method may mainly inject noise in a training process, function as a regularizer, and activate a conditional calculation. However, the random clipping-based quantization method may not be practical because the characteristics of a noise data distribution need to be known. The probability distribution-based quantization method may need to be based on a hypothesis that weight data is in a discrete distribution, and require prior knowledge of a known weight data distribution. However, it is difficult to obtain prior knowledge of the weight distribution in actual applications, and thus the universality of the method may be limited.

The typical quantization methods may have the following issues that significantly degrade the prediction performance of an original model.

The typical clipping-based quantization method that uses the maximum value may greatly degrade the performance of an original depth model after each clipping operation, and a quantized model may have to be trained again to increase the accuracy. Additionally, when the quantized model uses a clipped discrete value for a calculation, the quantized model may not readily converge in the training process due to a small parameter space. Additionally, the clipping operation may not use structural information of weights in a network. Further, the model may still need to be trained with an original precision value even after quantization, and thus a great amount of time may be consumed.

The quantization method that determines the clipping parameter based on the cross entropy theory may not calculate an optimal quantization parameter when the distribution of original input data is sparse or asymmetric. Thus, when using the quantization parameter that is not the optimal parameter, it may affect the prediction performance of an original model.

The vector quantization method based on K-means clustering may have a large calculation amount. Compared to the clipping quantization method, the vector quantization method may not readily obtain an integer weight. Vector quantization may be generally used to quantize a pre-trained model. Thus, when a task is to train a quantized depth model from the start, a preset clipping function may be required, which may be difficult to preset in practical applications.

The random clipping quantization method may adopt a random roundoff clipping-based quantization method. This method may, however, need to estimate a large number of intermediate parameters with great deviations. These deviations may result in oscillations of a loss function in the training process, which may greatly affect the prediction performance of the model.

The probability-based quantization method may need to define in advance an appropriate weight distribution. However, finding in advance such an appropriate weight distribution for a model may not be easy. Additionally, many quantization methods may have to traverse a significant solution space due to limited prior knowledge, and consume a great amount of time for a calculation process.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a processor-implemented neural network model quantization method includes receiving a neural network model; calculating a quantization parameter corresponding to an operator of the received neural network model to be quantized based on bisection approximation; and quantizing the operator of the received neural network model to be quantized based on the calculated quantization parameter, and obtaining a neural network model having the quantized operator.

The calculating of the quantization parameter corresponding to the operator to be quantized may include receiving input data of the operator to be quantized by verifying the neural network model with a verification dataset; and calculating a quantization parameter corresponding to a minimum mean squared error (MSE) of the input data of the operator to be quantized before and after quantization based on the input data of the operator to be quantized, by implementing bisection approximation.

The calculating of the quantization parameter corresponding to the minimum MSE may include performing dimensionality reduction on the input data of the operator to be quantized; dividing the input data of the operator to be quantized after the performing of the dimensionality reduction into a plurality of data distribution intervals based on a statistical characteristic of the input data of the operator to be quantized after the dimensionality reduction, and obtaining an interval upper value array which is an array of upper values in each of the plurality of data distribution intervals; and searching for the quantization parameter corresponding to the minimum MSE by bisectionally approximating an intermediate point between a start point and an end point of each of the data distribution intervals, by implementing bisection approximation.

The quantization parameter may include at least one of a clipping parameter, a quantization factor parameter, and a clipping factor parameter of each of the plurality of data distribution intervals.

The searching for the quantization parameter may include initializing the minimum MSE to be an initial MSE of each of the plurality of data distribution intervals when obtaining the interval upper value array each time for each of the plurality of data distribution intervals; calculating an MSE of an approximate point of each of the plurality of data distribution intervals by bisectionally approximating the intermediate point between the start point and the end point of each of the plurality of data distribution intervals; updating the minimum MSE by implementing the MSE of the approximate point when the MSE of the approximate point is less than the minimum MSE; and outputting the quantization parameter corresponding to the minimum MSE when traversing the data distribution intervals, wherein the initial MSE corresponds to a quantization parameter corresponding to an intermediate point between a start point and an end point of each of the data distribution intervals, and wherein the MSE of the approximate point corresponds to a quantization parameter corresponding to an approximate point of each of the data distribution intervals.

The operator of the received neural network model to be quantized may be a quantizable operator comprised in the neural network model, wherein the quantizable operator is an operator of which a ratio of parameters comprised in an operator of the neural network model to all parameters of the neural network model exceeds a threshold value, or an operator which belongs to a compute-intensive operator.

The method may include inserting a quantization indicating operator in front of a quantizable operator of the neural network model and indicating the quantizable operator, before the calculating of the quantization parameter corresponding to the operator of the neural network model to be quantized.

The indicating of the quantizable operator may include verifying whether weight data is present in input data of the quantizable operator; wherein when the weight data is not present in the input data of the quantizable operator, inserting the quantization indicating operator in front of the quantizable operator; and wherein when the weight data is present in the input data of the quantizable operator, inserting the quantization indicating operator in front of the quantizable operator, and inserting the quantization indicating operator in front of the weight data to indicate whether the weight data needs to be quantized.

The neural network model may be a deep learning neural network model trained to perform at least one of image recognition, natural language processing, and recommendation system processing.

In a general aspect, a neural network model quantization apparatus includes a data acquirer configured to receive a neural network model; a quantization parameter calculator configured to calculate a quantization parameter corresponding to an operator of the received neural network model to be quantized based on bisection approximation; and a quantization implementor configured to quantize the operator to be quantized based on the quantization parameter, and obtain a neural network model having the quantized operator.

The quantization parameter calculator may be configured to obtain input data of the operator to be quantized by verifying the neural network model using a verification dataset; and calculate a quantization parameter corresponding to a minimum mean squared error (MSE) of the input data of the operator to be quantized before and after quantization based on the input data of the operator to be quantized, using bisection approximation.

For the calculating of the quantization parameter corresponding to the minimum MSE, the quantization parameter calculator may be configured to: perform dimensionality reduction on the input data of the operator to be quantized; divide the input data of the operator to be quantized after the performing of the dimensionality reduction into a plurality of data distribution intervals based on a statistical characteristic of the input data of the operator to be quantized after the dimensionality reduction, and obtain an interval upper value array which is an array of upper values in each of the plurality of data distribution intervals; and search for the quantization parameter corresponding to the minimum MSE by bisectionally approximating an intermediate point between a start point and an end point of each of the data distribution intervals by implementing bisection approximation.

The quantization parameter may include at least one of a clipping parameter, a quantization factor parameter, and a clipping factor parameter of each of the plurality of data distribution intervals.

For the searching for the quantization parameter, the quantization parameter calculator may be configured to initialize the minimum MSE to be an initial MSE of each of the plurality of data distribution intervals, when obtaining the interval upper value array each time for each of the plurality of data distribution intervals; calculate an MSE of an approximate point of each of the plurality of data distribution intervals by bisectionally approximating the intermediate point between the start point and the end point of each of the plurality of data distribution intervals; update the minimum MSE by implementing the MSE of the approximate point when the MSE of the approximate point is less than the minimum MSE; and output the quantization parameter corresponding to the minimum MSE when traversing the data distribution intervals, wherein the initial MSE corresponds to a quantization parameter corresponding to an intermediate point between a start point and an end point of each of the data distribution intervals, and wherein the MSE of the approximate point corresponds to a quantization parameter corresponding to an approximate point of each of the data distribution intervals.

The operator of the received neural network model to be quantized may be a quantizable operator comprised in the neural network model, wherein the quantizable operator may be an operator of which a ratio of parameters comprised in an operator of the neural network model to all parameters of the neural network model exceeds a threshold value, or an operator which belongs to a compute-intensive operator.

The apparatus may further include a quantization indicator configured to indicate a quantizable operator of the neural network model by inserting a quantization indicating operator in front of the quantizable operator of the neural network model, and provide the quantizable operator to the quantization parameter calculator.

The quantization indicator may be configured to determine whether weight data is present in input data of the quantizable operator; wherein when the weight data is not present in the input data of the quantizable operator, insert the quantization indicating operator in front of the quantizable operator; and wherein when the weight data is present in the input data of the quantizable operator, insert the quantization indicating operator in front of the quantizable operator and insert the quantization indicating operator in front of the weight data to indicate whether the weight data needs to be quantized.

The neural network model is a deep learning neural network model trained to perform at least one of image recognition, natural language processing, and recommendation system processing.

Other features and aspects will be apparent from the following detailed description, the drawings, and the claims.

### BRIEF DESCRIPTION OF DRAWINGS

FIG. 1 illustrates an example neural network model quantization method, in accordance with one or more embodiments.

FIG. 2 illustrates an example monotonic trend of a mean squared error (MSE) reduction, in accordance with one or more embodiments.

FIG. 3 illustrates an example bisection approximation, in accordance with one or more embodiments.

FIG. 4 illustrates an example neural network model quantization apparatus, in accordance with one or more embodiments.

FIG. 5 illustrates an example structure of a neural network model quantization method, in accordance with one or more embodiments.

FIG. 6 illustrates an example of a quantization factor parameter calculated by a neural network model quantization method, in accordance with one or more embodiments, and an example of a quantization factor parameter calculated by a typical quantization method.

FIG. 7 illustrates an example of indicating quantization by a quantization indicator of an example neural network model quantization apparatus, in accordance with one or more embodiments.

FIG. 8 illustrates an example of calculating a quantization parameter by a quantization parameter calculator of an example neural network model quantization apparatus, in accordance with one or more embodiments.

FIG. 9 illustrates an example of obtaining a neural network model having a quantized operator by a quantization implementor of an example neural network model quantization apparatus, in accordance with one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of the application, may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

Also, in the description of example embodiments, detailed description of structures or functions that are thereby known after an understanding of the disclosure of the present application will be omitted when it is deemed that such description will cause ambiguous interpretation of the example embodiments.

The present disclosure relates to a method and apparatus for quantizing a neural network model by implementing bisection approximation. Compared to a neural network model before quantization, a quantized neural network model after quantization may occupy a relatively small storage space and improve memory utilization efficiency. Additionally, when the quantized neural network model is executed by one or more processors, for example, a central processor, a graphics processor, and/or a neural processor, in an electronic device (e.g., a mobile device) to perform tasks such as, but not limited to, recognition, the central processor, the graphics processor, and/or the neural processor may perform corresponding calculations based on the quantized neural network model with a relatively small overhead, without affecting the accuracy of the tasks such as recognition. Compared to the neural network model before quantization, the quantized neural network model obtained using the method of quantizing a neural network model through bisection approximation according to the example embodiments may improve the hardware performance of the electronic device, for example, improve the memory utilization and/or reduce the overhead of the central processor, the graphics processor, and/or the neural processor. The neural network model may be configured to perform, as non-limiting examples, object classification, object recognition, and image recognition by mutually mapping input data and output data in a nonlinear relationship based on deep learning. Such deep learning is indicative of processor implemented machine learning schemes for solving issues, such as issues related to automated image or speech recognition from a data set, as non-limiting examples.

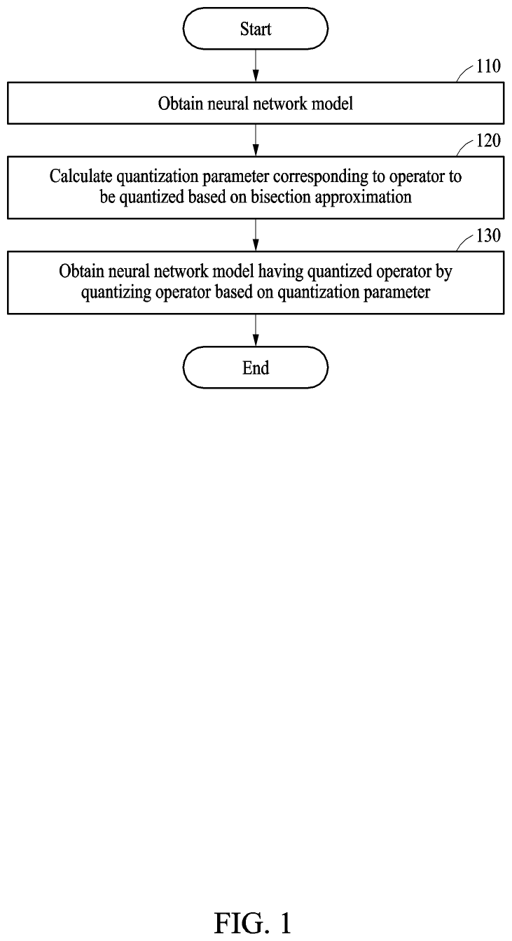

Hereinafter, a method and apparatus for quantizing a neural network model (hereinafter simply referred to as a neural network model quantization method and apparatus) in accordance with one or more embodiments will be described with reference to FIGS. 1 through 9.

FIG. 1 illustrates an example neural network model quantization method, in accordance with one or more embodiments. The operations in FIG. 1 may be performed in the sequence and manner as shown, although the order of some operations may be changed or some of the operations omitted without departing from the spirit and scope of the illustrative examples described. Many of the operations shown in FIG. 1 may be performed in parallel or concurrently. One or more blocks of FIG. 1, and combinations of the blocks, can be implemented by special purpose hardware-based computer that perform the specified functions, or combinations of special purpose hardware and computer instructions.

Referring to FIG. 1, in operation 110, a neural network model quantization apparatus may obtain a neural network model.

The neural network model may be a neural network model that is trained in advance. In an example, the neural network model may be a deep learning model of which original precision is a floating-point number. In an example, the neural network model may be obtained from a database (DB), for example, a DB of a server (e.g., a cloud server) or a DB of a mobile device with limited memory. However, examples are not limited to obtaining a neural network model from a DB, and it is also possible to obtain a neural network model from another hardware device. In an example, the neural network model may be a deep learning neural network model trained to perform, as non-limiting examples, one of image recognition, natural language processing, and recommendation system processing.

In operation 120, the neural network model quantization apparatus may calculate a quantization parameter corresponding to an operator to be quantized based on bisection approximation. Bisection approximation may be desirably bidirectional bisection approximation. Herein, it is noted that use of the term ‘may’ with respect to an example or embodiment, e.g., as to what an example or embodiment may include or implement, means that at least one example or embodiment exists where such a feature is included or implemented while all examples and embodiments are not limited thereto.

As described herein, by calculating the quantization parameter corresponding to the operator to be quantized based on bisection approximation, it is possible to find a quantization parameter while effectively reducing a quantization parameter search space at the same time.

In an example, the operator of the neural network model to be quantized may include a quantizable operator of the neural network model. In an example, when a ratio of parameters included in the operator of the neural network model to all parameters of the neural network model exceeds a threshold value or the operator corresponds to a compute-intensive operator, the operator may be classified as the quantizable operator. The compute-intensive operator may be an operator that includes a large number of matrix multiplication operations, which may be, for example, a convolution operator, a fully connected layer operator, and the like.

The neural network model quantization method may indicate the quantizable operator by inserting a quantization indicating operator in front of the quantizable operator before calculating the quantization parameter corresponding to the operator to be quantized. That is, the quantization indicating operator may be inserted to indicate that the operator should be quantized. In an example, the neural network model quantization method may determine whether weight data is present in input data of the quantizable operator. In the absence of the weight data from the input data of the quantizable operator, the neural network model quantization method may insert the quantization indicating operator in front of the quantizable operator. In the presence of the weight data in the input data of the quantizable operator, the neural network model quantization method may insert the quantization indicating operator in front of the quantizable operator and in front of the weight data to indicate whether the weight data should be quantized.

The neural network model quantization method may add the quantization indicating operator in front of the quantizable operator having a weight, and record subsequent weight quantization parameter information of the operator, and may thereby complete quantization of the weight operator without prior knowledge of a weight data distribution. That is, the neural network model quantization method may individually calculate a quantization parameter set that is most suitable for a neural network model according to original input data without a predefined clipping function and prior information of a weight distribution, and may thus reduce a potential difficulty in acquiring information on a method of quantizing the original neural network model.

That is, in the example of a quantizable operator, the neural network model quantization method may verify whether input data includes weight data. In the presence of the weight data, the neural network model quantization method may insert different quantization indicating operators (two in total) to indicate whether the weight data needs quantization.

However, in the absence of the weight data, the neural network model quantization method may indicate a quantization indicating operator only in front of the quantizable operator, and process a subsequent operator without inserting the quantization indicating operator in the data. The neural network model quantization method may complete such an indicating task with all quantizable operators of a deep learning model D_{FP} (or a neural network model). In such an example, the deep learning model of which original precision is a floating-point number may be represented as D_{FP}=(Q_{N}, Q_{M}), in which Q_{N} denotes a set of operators that need quantization in a corresponding model, N denotes the number of operators that need quantization, Q_{M} denotes a set of operators that do not need quantization in the model, and M denotes the number of operators that do not need quantization.

In an example, the neural network model quantization method may obtain input data of each operator to be quantified by verifying the neural network model using a verification dataset. Subsequently, the neural network model quantization method may calculate a quantization parameter corresponding to a minimum mean squared error (MSE) of the input data of each operator to be quantized before and after quantization based on the input data of each operator to be quantized, by using bisection approximation. The neural network model quantization method may calculate a quantization error (that is, an MSE between quantized data and data before quantization) of each data in subintervals of a distribution of currently quantized data, thereby replacing a cross entropy theory-based solution process among existing methods. The quantization error calculated as described above may reflect therein characteristics of the data distribution better than when calculating the asymmetry of the data distribution compared to the entropy theory, and may be more suitable for the neural network model.

The higher suitability of the neural network model quantization method for the neural network model may be because a large amount of valid positive data is clipped or truncated in the typical cross entropy theory-based solution process and a quantization parameter does not include most of the positive data.

In an example, to process input data of an operator to be quantized by better utilizing bisection approximation such that a large amount of valid positive data is clipped, the neural network model quantization method may reduce a dimension of the input data of each operator to be quantized.

In an example, the neural network model quantization method may inject a verification dataset X_{R} into the neural network model and extract input data of each operator to be quantized, and reduce the dimension to convert the original input data into a one-dimensional (1D) array Xᵢ, i∈[0,N] from a multi-dimensional matrix. In this example, N denotes the number of operators to be quantized, which is convenient for dividing it into intervals and determining an upper value of each interval. X_{R} denotes a small dataset arbitrarily extracted from a test set of a prediction model.

Additionally, after dimensionality reduction, the neural network model quantization method may divide the input data of each operator to be quantized into a plurality of data distribution intervals based on statistical characteristics of the input data of each operator to be quantized after dimensionality reduction, and obtain an interval upper value array which records an upper value of each of the data distribution intervals.

In an example, the neural network model quantization method may divide the input data of each operator to be quantized into intervals. This is to record an upper value (or an upper limit value) of each interval. For a flow of dividing the data distribution intervals in the neural network model quantization method, reference may be made to <Algorithm 1> below.

<Algorithm 1>: Method of Dividing Data Distribution Intervals

For symbols in <Algorithm 1>, X denotes a set obtained after converting input data of an operator to be quantized into an 1D array, n_{bins} denotes a generalizable value used to divide X into n_{bins} intervals, and Tₙ_{_{bins}}₊₁ denotes an upper value array that divides the intervals.

An input of <Algorithm 1> may be the set X obtained after the conversion of the input data of the operator to be quantized into the 1D array.

An output of <Algorithm 1> may be the upper value array Tₙ_{_{bins}}₊₁.

1. Calculate a maximum interval (thres=max(|Xₘᵢₙ|, |Xₘₐₓ|)) in a range of data values of X, in which Xₘᵢₙ denotes a minimum value of X and Xₘₐₓ denotes a maximum value of X.

2. Calculate an interval width

$$inc = \frac{2 \times thres}{{n}_{bins}} .$$

3. Divide X into n_{bins} intervals, and record Tₙ_{_{bins}}₊₁. For j from 0 to n_{bins},

Tⱼ=−thres+(inc×j),j∈[0,n_{bins}].

4. Return

Referring to <Algorithm 1>, the neural network model quantization method may first extract statistical characteristic distribution information P(Xᵢ) of an input dataset Xᵢ of each operator to be quantized, and determine a quantization interval threshold value, thres, based on an absolute value of an extreme value as represented by Equation 1 below, in consideration of the minimum value Xₘᵢₙ and the maximum value Xₘₐₓ.

thres=max(|Xᵢ_{ₘᵢₙ}|,|Xᵢ_{ₘₐₓ}|). Equation 1

Subsequently, the neural network model quantization method may divide the input data into the number n_{bins} of intervals based on thres and a known data distribution, and obtain a length, inc, of each interval as represented by Equation 2 below.

Equation 2:

$$inc = \frac{2 \times thres}{{n}_{bins}}$$

In this example, n_{bins}=8001, which is a generalized set value, may indicate the number of data distribution intervals in which the original input data of each operator to be quantized is quantized from original floating-point precision to integer precision.

Lastly, the neural network model quantization method may record an upper value of each data distribution interval by using an interval upper value array Tₙ_{_{bins}}₊₁. An upper value Tⱼ of a jth subinterval may be represented by Equation 3 below.

Tⱼ=−thres+(inc×j),j∈[0,n_{bins}] Equation 3

The neural network model quantization method may divide the data distribution intervals and then bisectionally approximate an intermediate point between a start point and an end point of each data distribution interval using bisection approximation, and retrieve a quantization parameter corresponding to a minimum MSE. In general, a typical quantization method may not select an optimal quantization parameter suitable for an entire data when original input data of an operator to be quantized is asymmetric or non-uniform. Thus, the neural network model quantization method may employ a method of individually calculating quantization factors by combining data distribution subintervals and the minimum MSE to effectively overcome a potential issue arising from quantization of a non-uniform data distribution.

The neural network model quantization method may combine statistical distribution characteristics of different original input data, individually calculate an optimal quantization factor parameter set suitable for a distribution of each input data, and select and obtain an optimal quantization factor parameter suitable for entire data through a minimum MSE theory. Thus, the neural network model quantization method may calculate the optimal quantization factor parameter and perform model quantization, regardless of whether the input data is symmetrically or asymmetrically distributed.

The quantization parameter described herein may include at least one of a clipping parameter of a data distribution interval, a quantization factor parameter, and a clipping factor parameter.

Hereinafter, a method using bisection approximation will be described in conjunction with a clipping parameter α as an example.

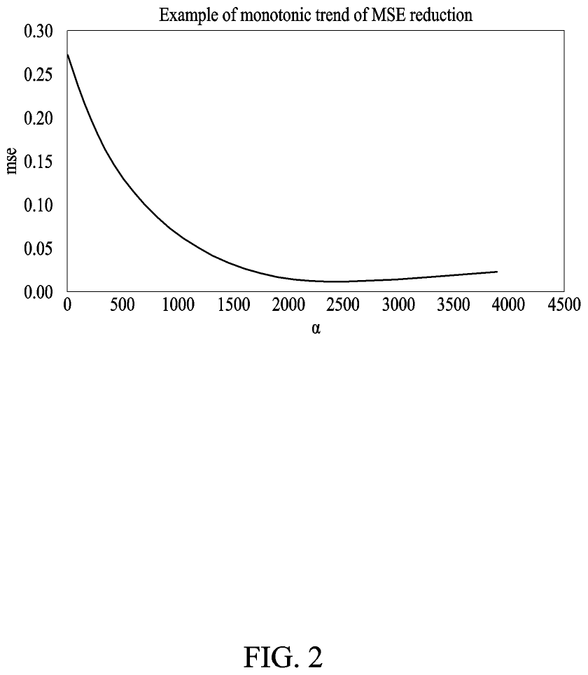

The neural network model quantization method may rapidly search for a subscript of a segment interval corresponding to an optimal clipping parameter corresponding to a minimum MSE using bisection approximation. A trend of how an MSE changes exhibits a reduced monotonic decrease, and an example of such an MSE reduced monotonic trend is illustrated in FIG. 2.

FIG. 2 illustrates an example of a monotonic trend of an MSE reduction, in accordance with one or more embodiments.

Referring to FIG. 2, an overall change trend may exhibit a decreasing curve. However, when a clipping parameter a is extremely large, the curve may have a slightly upward section.

Thus, an optimal clipping parameter α may be finally obtained by continuously approximating a minimum MSE from two end points toward an intermediate bisection using bisection approximation.

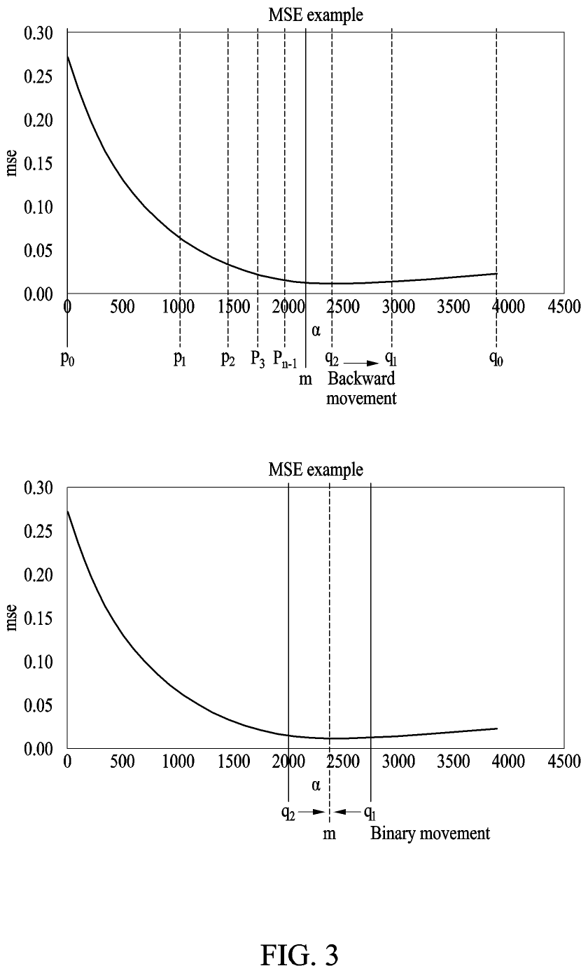

FIG. 3 illustrates examples of bisection approximation, in accordance with one or more embodiments.

For issues such as great redundant calculations and a great quantization time that arise when traversing a search space of clipping factors using an existing method, the examples provide a method of reducing a search space of quantization parameters to be traversed using bisection approximation according to an MSE reduction monotonic change rule, by which it is possible to greatly improve the time consumed for resolving an issue of quantization parameters.

A neural network model quantization method of example embodiments described herein may reduce a search space of Tₙ_{_{bins}}₊₁ by calculating an optimal clipping parameter a through bisection approximation, find the optimal clipping parameter α corresponding to a minimum MSE before and after quantization, and prepare for the implementation of quantization.

To calculate the minimum MSE, the neural network model quantization method may initialize the minimum MSE to be an initial MSE in a data distribution interval when obtaining an interval upper value array for each data distribution interval. In this example, the initial MSE may correspond to a quantization parameter corresponding to an intermediate point between a start point and an end point of the data distribution interval.

Additionally, the neural network model quantization method may calculate an MSE of an approximate point of the data distribution interval by bisectionally approximating the intermediate point between the start point and the end point of the data distribution interval. In this example, the MSE of the approximate point may correspond to a quantization parameter corresponding to the approximate point of the data distribution interval.

When the MSE of the approximate point is less than the minimum MSE, the neural network model quantization method may update the minimum MSE by using the MSE of the approximate point. For a detailed flow thereof, reference may be made to <Algorithm 2> below.

<Algorithm 2>: Method of Calculating an Optimal Clipping Parameter α by Bisection Approximation

For symbols in <Algorithm 2>, X denotes a set obtained after converting input data of an operator to be quantized into a 1D array, Tₙ_{_{bins}}₊₁ denotes an upper value array obtained after interval division, and a denotes an optimal clipping parameter.

An input of <Algorithm 2> may be the set X after the conversion of the input data of the operator to be quantized into the 1D array, and the upper value array Tₙ_{_{bins}}₊₁ after the interval division.

An output of <Algorithm 2> may be the optimal clipping parameter α.

1. Calculate a start position

$$init = \frac{{n}_{bins}}{2} + \frac{{2}^{bit} - 1}{2}$$

of a traversal of Tₙ_{_{bins}}₊₁ array, an end position (end=n_{bins}), initialization (p=init, q=end),
initialize a minimum (MSEₘᵢₙ=MAX_INT) and a current optimal subscript (idxₘᵢₙ=0).

2. While p<q−1

Determine whether current subscripts (p, q) and previous loop subscripts (pre_p, pre_q) are exactly the same, and if they are exactly the same, it indicates that p and q have not changed, and thus jump to 16.

3. Record positions of the previous subscripts (pre_p=p, pre_q=q).

4. Calculate a subscript at an intermediate position (m=(p+q)/2).

5. Obtain MSEs corresponding to the subscripts p, q, and m according to <Algorithm 3>.

MSEₚ=MSE(X,Tₚ),

MSE_{q}=MSE(X,T_{q}),

MSEₘ=MSE(X,Tₘ),

6. While MSEₚ>MSEₘ and p<m−1,

7. p=(p+m)/2

8. Update and calculate MSEₚ=MSE(X, Tₚ).

9. If p<m−1,

10. p=(p*2)−m, and when p is out of a range, p=init,

11. While MSE_{q}>MSE_{q} and q>m,

12. q=(q+m)/2

13. Update and calculate MSE_{q}=MSE(X, T_{q}).

14. If q>m

15. q=(q*2)−m, and when q is out of a range, q=end,

16. For i from p to q,

17. Calculate MSEᵢ and determine whether it is less than MSEₘᵢₙ, when it is, update MSEₘᵢₙ and record idxₘᵢₙ=1, otherwise traverse a subsequent i.

18. Record an optimal clipping parameter α=T_{idx}_{ₘᵢₙ}.

19. Return the optimal clipping parameter α.

Referring to <Algorithm 2>, in the neural network model quantization method, the operation of calculating an optimal clipping parameter using bisection approximation may include the following steps.

In a first operation, the neural network model quantization method may initialize subscripts of a start point and an end point of a traversal. The neural network model quantization method may calculate a traversal start point p and a traversal end point q of a start interval through Equation 4 below.

$$p = \frac{{n}_{bins}}{2} + \frac{{2}^{bit} - 1}{2} , \\ q = {n}_{bins} \qquad Equation 4$$

In Equation 4 above, bit denotes an integer digit after quantization (generally an integer power of 2 (e.g., 8, 16, etc.)).

Additionally, the neural network model quantization method may calculate a subscript at an intermediate position between the start subscript and the end subscript as represented by Equation 5 below.

m=(p+q)/2 Equation 5

In a second operation, in the neural network model quantization method, a subscript of an optimal clipping variable may need to be positioned at an intermediate position (refer to FIG. 2) because an MSE change trend exhibits a reduced monotonic decrease. Thus, until MSEₚ≤MSEₘ through a calculation, p may need to continue to approach an intermediate subscript m by steps of bisection and the subscript p may move one step backward to move out of a loop.

In this example, a forward step calculation of p may be p=(p+m)/2, and a backward step calculation of p may be p=(p*2)−m.

Similarly, a forward step calculation of q may be q=(q+m)/2, and a backward step calculation of q may be q=(q*2)−m.

In a third operation, the neural network model quantization method may traverse an upper value array Tₙ_{_{bins}}₊₁ of a divided interval from p to q, and calculate quantization factor parameters α, scale, clipₘᵢₙ, and clipₘₐₓ and a minimum MSE of a current subinterval according to Equation 6 below. For a detailed flow thereof, reference may be made to <Algorithm 3>: Method of calculating an MSE below.

$$α = {T}_{j} , j ∈ [ p , q ] \\ scale = \frac{α}{{2}^{bit - 1}} \\ {clip}_{min} = - ( {2}^{bit - 1} ) , {clip}_{max} = {2}^{bit - 1} \\ Q = Clip ( Round ( \frac{X}{scale} ) , {clip}_{min} , {clip}_{max} ) \\ {X}^{′} = Q \times scale \\ MSE = \frac{{\sum }_{i = 0}^{N} {( {X}^{′} - X )}^{2}}{N} \qquad Equation 6$$

In Equation 6 above, bit denotes an integer digit of the accuracy of a quantized model. Clip(.) denotes a clipping function, and a detailed calculation may be represented by Equation 7 below.

$$Clip ( x , min , max ) = \{ \begin{matrix}min , & x ∈ ( - ∞ , min ) \\ x , & x ∈ [ min , max ) \\ max , & x ∈ [ max , + ∞ )\end{matrix} \qquad Equation 7$$

The neural network model quantization method may obtain a subscript of a clipping parameter corresponding to a minimum MSE after a traversal is completed, and return the optimal clipping parameter α=Tⱼ. Here, MSEⱼ is a minimum value.

In <Algorithm 3> which is the method of calculating an MSE, a search space may be traversed, and an MSE between a dequantized value and an original value of a current clipping parameter may be calculated and input. Based on whether the calculated value is a global minimum value, whether this clipping parameter is optimal may be determined. Based on this determination, whether a current quantization factor parameter is optimal may be determined.

<Algorithm 3> Method of Calculating an MSE

For symbols in <Algorithm 3>, X denotes a set obtained by converting input data of an operator to be quantized into a 1D array, and a denotes an optimal clipping parameter.

An input of <Algorithm 3> may be the set X after the conversion of the input data of the operator to be quantized into the 1D array, and the clipping parameter α.

An output of <Algorithm 3> may be an MSE.

1. Calculate a quantization parameter, and when

$$Q = Clip ( Round ( \frac{X}{scale} ) , {clip}_{min} , {clip}_{max} ) ,$$

bit denotes an integer precision digit of D_{FP32} quantized to D_{INT}.

2. Calculate minimum and maximum values (clipₘᵢₙ=−(2^{bit-1}), clipₘₐₓ=2^{bit-1}) of a clipping variable.

3. Calculate a quantized dataset

$$scale = \frac{α}{{2}^{bit - 1}} ,$$

where

$$Clip ( x , min , max ) = \{ \begin{matrix}min , & x ∈ ( - ∞ , min ) \\ x , & x ∈ [ min , max ) \\ max , & x ∈ [ max , + ∞ )\end{matrix} .$$

4. Dequantize the dataset Q to obtain a dataset X′ (X′=Q×scale).

5. Calculate an MSE

$$MSE = \frac{{\sum }_{i = 0}^{N} {( {X}^{′} - X )}^{2}}{N}$$

in which N denotes the number of elements of the dataset X.

6. Return the MSE.

Referring back to FIG. 1, in operation 130, the neural network model quantization method may quantize the operator to be quantized based on the quantization parameter to obtain a neural network model having the quantized operator.

The neural network model quantization method may realize a quantization operation and a dequantization operation of the operator to be quantized by using an optimal clipping parameter α, an optimal quantization factor (scale), and corresponding clipₘᵢₙ and clipₘₐₓ.

The neural network model quantization method may calculate an optimal quantization factor and a clipping parameter array as represented by Equation 8 below.

$$scale = \frac{α}{{2}^{bit - 1}} , \\ {clip}_{min} = - ( {2}^{bit - 1} ) , {clip}_{max} = {2}^{bit - 1} \qquad Equation 8$$

Additionally, the neural network model quantization method may assign the optimal scale and clipₘᵢₙ and clipₘₐₓ to a quantization indicating operator in front of each operator to be quantized.

Subsequently, the neural network model quantization method may convert all quantization indicating operators of a quantizable model to a basic operation mode (multiplication, rounding off, clipping (or truncation), transformation) through underlying hardware (or basic hardware (e.g., a GPU, an NPU, etc.)), implement integer quantization of each operator to be quantized by using the optimal quantization factor parameter (scale), and implement a dequantization operation after an operation is performed on each operator to be quantized.

Lastly, the neural network model quantization method may output an original depth model D_{INT} having a bit integer precision after quantization.

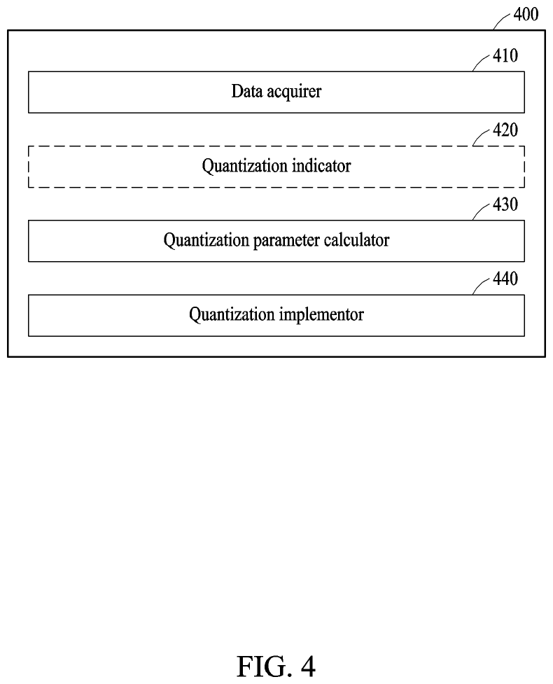

FIG. 4 illustrates an example neural network model quantization apparatus, in accordance with one or more embodiments.

Referring to FIG. 4, a neural network model quantization apparatus 400 may include a data acquirer 410, a quantization indicator 420, a quantization parameter calculator 430, and a quantization implementor 440.

The data acquirer 410 may obtain a neural network model. The quantization parameter calculator 430 may calculate a quantization parameter corresponding to a quantizable operator based on bisection approximation.

The quantization implementor 440 may quantize an operator to be quantized based on the quantization parameter, and obtain a neural network model having the quantized operator.

That is, the data acquirer 410 may perform a data obtaining operation, the quantization parameter calculator 430 may perform a quantization parameter calculating operation, and the quantization implementor 440 may perform a quantization operation. The data obtaining operation, the quantization parameter calculating operation, the quantization operation, and a DB updating operation have been described above with reference to FIG. 1, and thus a more detailed and repeated description thereof will be omitted here for brevity. Additionally, the neural network model quantization apparatus 400 may selectively include a quantization indicator 420 configured to indicate an operator to be quantized.

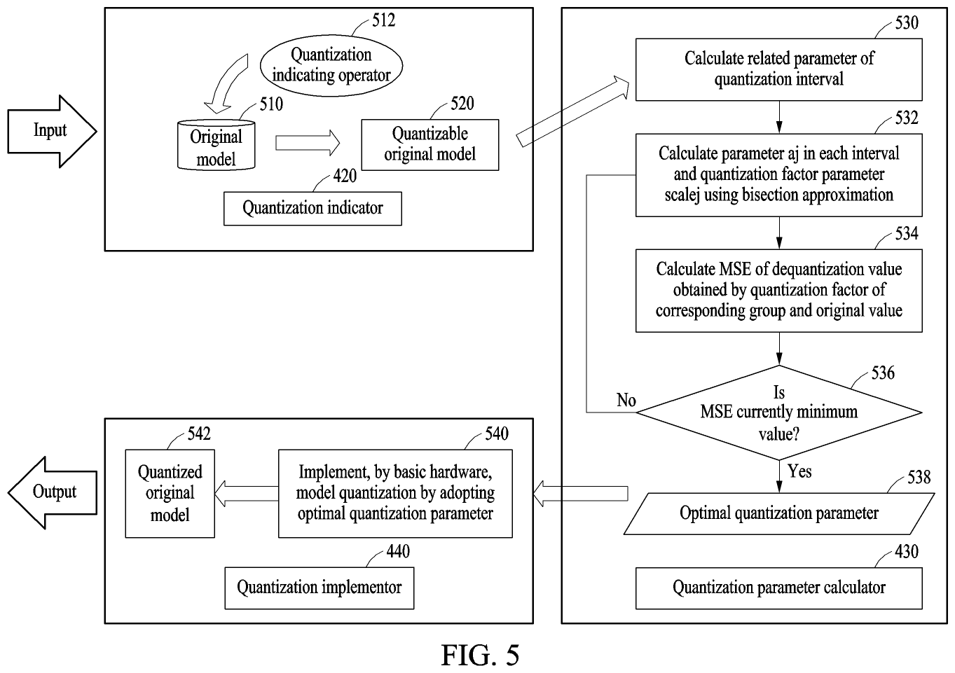

FIG. 5 illustrates an example structure of an example neural network model quantization method, in accordance with one or more embodiments.

Referring to FIG. 5, an input may correspond to an obtained neural network model (that is, an original model) 510. The quantization indicator 420 may generate a quantizable original model 520 by inserting a quantization indicating operator 512 into the original model 510. In an example, the quantization indicator 420 may identify and indicate each quantizable operator from the original model 510 to use it for a calculation for the implementation of quantization. The quantization indicator 420 may finally output the quantizable original model 520 which is an original floating-point precision model having the quantization indicating operator 512. The quantization indicator 420 may traverse each operator of a neural network model, select all operators to be quantized, insert the quantization indicating operator 512 (or a quantization simulating operator) in front of these operators, and use them to implement a quantization operation in a subsequent quantization implementing module.

In the example of FIG. 5, the quantization indicator 420 may provide the quantizable original model 520 to the quantization parameter calculator 430. The quantization parameter calculator 430 may calculate a quantization parameter set of an original model, and the quantization implementor 440 may then complete a quantization calculation of the original model. The quantization parameter calculator 430 may verify a dataset from the original model of a quantization indicating operator 512, and obtain a statistical distribution characteristic of original input data in operation 530, calculate a quantization parameter (e.g., a quantization factor (e.g., scale) and clipping factor parameters (e.g., clipₘᵢₙ and clipₘₐₓ)) in operation 532, calculate an MSE between a dequantization value obtained by a quantization factor of a corresponding group and an original value in operation 534, verify whether the MSE is currently a minimum value in operation 536, and output, as an optimal quantization parameter, the calculated quantization parameter (e.g., the quantization factor (e.g., scale) and the clip factor parameters (e.g., clipₘᵢₙ and clipₘₐₓ)) to the quantization implementor 440 in operation 538.

Referring to FIG. 5, the quantization implementor 440 may complete quantization and dequantization calculation functions in operation 540, and output a final quantization model 542. In one or more examples, a quantization parameter group may be assigned to a quantization indicating operator that implements a quantization operation mode (e.g., multiplication, rounding off, clipping mode, data type conversion, etc.) in basic hardware. Lastly, the neural network model quantization apparatus 400 may obtain a quantized integer precision model corresponding to an input original depth model.

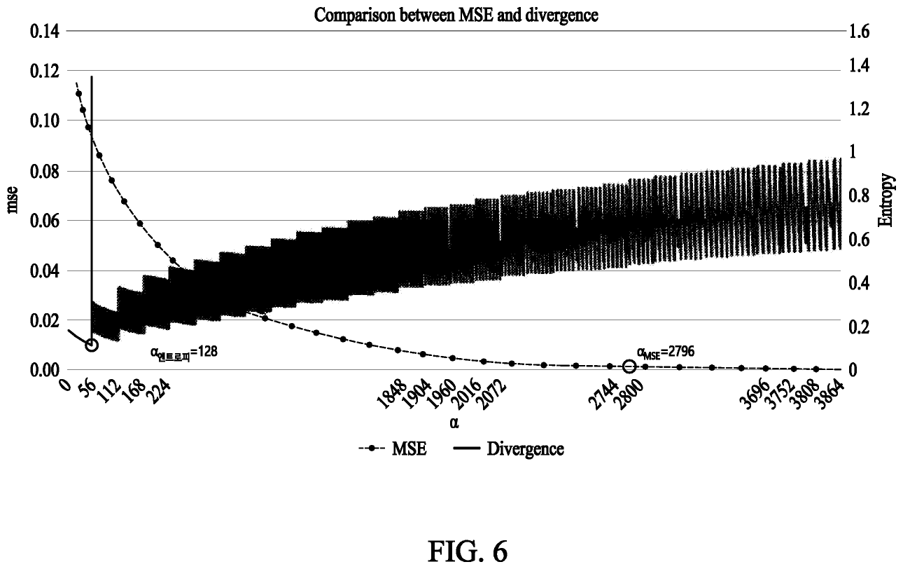

FIG. 6 illustrates an example of a quantization factor parameter calculated by a neural network model quantization method, in accordance with one or more embodiments, and an example of a quantization factor parameter calculated by a typical quantization method.

A typical quantization method may determine a clipping parameter α according to a data distribution before and after quantization and a predefined clipping function, which may lead to a large amount of semi-axial data clipping or truncation and finally lead to degradation of overall accuracy of the model after quantization.

However, as proposed herein, when a clipping parameter α is determined by combining an MSE theory and a data distribution characteristic, calculating an upper value of each interval of divided intervals, and obtaining an MSE, the great amount of semi-axial data may be included, and a minimum error after quantizing input data of a layer may be guaranteed at the same time. Thus, the overall accuracy of a quantization model may not decrease considerably.

To test the effectiveness of the quantization method described herein, tests were performed on the quantization method of the present disclosure and the existing method using a plurality of test datasets. The results of the tests are shown in <Table 1> below.

TABLE 1
Test results

| Model names | BERT Base | NCF | ResNet-50 | |
|---|---|---|---|---|
| (Test sets) | (SQuAD1.1) | (ML-1M) | (ImageNet2012) | |
| Accuracy of original | F1 = 88.30% | HQ@10 = 68.73% | Topi = 76.456% | |
| model D_{FP} | | | | |
| Accuracy of cross | F1 = 78.14% | HQ@10 = 67.91% | Topi = 76.226% | |
| entropy-based existing | | | | |
| quantization model | | | | |
| Accuracy of a model | F1 = 87.49% | HQ@10 = 68.10% | Topi = 76.276% | |
| Dint after quantization | | | | |
| performed by the | | | | |
| method described | | | | |
| herein | | | | |
| Size of original model | 435,193,730 | 1,571,198 | 128,805,650 | |
| D_{FP} (byte) | | | | |
| Size of quantized model | 110,062,466 | 393,566 | 31,911,506 | |
| D_{INT} (byte) | | | | |
| Operation time of | 263.27 (ms) | 33.97 (us) | 32.49 | (ms) |
| original model D_{FP} | | | | |
| Operation time of | 117.87 (ms) | 31.65 (us) | 12.61 | (ms) |
| quantized model D_{INT} | | | | |

SQuAD1.1 is a test dataset of a BERT model that uses F1 as an evaluation index, and ML-1M is a test dataset of an NCF model that uses HQ@10 as an evaluation index.

In an example, referring to Table 1 above, in an example of the BERT model which is a natural language processing model, the quantization method described herein implements quantization of an original model and has 8-bit integer precision (i.e., bit=8), and the prediction accuracy of a quantized model is not degraded significantly compared to that of the original model which is 32-bit floating-point precision. Additionally, the prediction performance may be greatly improved, compared to the typical cross entropy theory-based quantization. The quantization method described herein compresses the model size to be ¼ of that of the original model, and an operation speed of the quantized model may be 2.23 times higher than an operation speed of the original model.

In another example, in an example of an NCF model of a recommendation system, the quantization method described herein may be used to quantize weight data, and implement quantization even when weight distribution information is unknown. The model accuracy after quantization may not be degraded significantly, but may be slightly higher than the accuracy obtained by quantizing a weight using the typical cross entropy theory-based method. The model size is compressed to ¼ of that of the original model, and the operation speed of the model after quantization may not decrease. Thus, in a situation where a weight distribution is not known, the quantization method described herein may successfully complete quantization even for a model of the recommendation system.

In another example, in an example of ResNet-50 which is an image recognition model, when the quantization method described herein is used, the model accuracy may not be degraded significantly, but may be slightly greater than a quantization accuracy based on the typical cross entropy theory-based method. The model size may be compressed to ¼ of that of the original model. The operation speed of the quantized model may be 2.577 times higher than the operation speed of the original model.

As shown in Table 1 above, the quantization method described herein may greatly improve the operation speed of the original model while hardly compromising the prediction accuracy of the original model, and may greatly compress a storage space occupied by the original model. Additionally, the original model quantized according to the examples may be compatible to, and executable at, a backend such as a central processing unit (CPU) or a GPU. This may improve the applicability of the original depth model in many small devices with limited storage space, and may be more applicable to more hardware terminals.

In an example, in an example of a ReNet-50 network when performing an image recognition training task with a neural network, this model may include a large number of Conv2d operators, and may thus be suitable for image-related tasks. Images in an image dataset may be first transformed from pixels to lattice vectors and learned in a pre-classifier (typically a basic classifier such as a logistic regression classifier, a Bayesian classifier, etc.). Additionally, an error value of a loss function may be minimized during the training or learning, and a trained model may thereby be obtained. However, data types at a time of a calculation of the model may all be floating-point numbers, and a large space overhead may be needed to store the model. Thus, to complete the compression and storage of the model without affecting the prediction accuracy of the model, a convolution operator of the model may have to be quantified. By implementing the quantization method described herein, the size of the model may be significantly reduced while the original precision of the ResNet-50 model is maintained. Based on a clipping factor and a quantization parameter that are rapidly calculated by bidirectional bisection approximation, it is possible to read data by accurately mapping high-precision floating-point input data to a low-precision integer interval to obtain integer data and by transmitting the integer input data to a terminal such as a CPU, a GPU or a multicore NPU. Accordingly, the prediction time for each image data may be significantly reduced, and it may be ensured that the prediction accuracy is hardly affected.

In an example of the Bert-Large model when performing a natural language processing task implementing a neural network, original text data may be first converted to a word vector storage through a word2vec toolkit and then be input to the Bert-Large model having a bidirectional transformer, and training may thereby be prepared. However, the size of the model may still use too much memory, and it may thus be quantized as well. In this model, a ratio of a DENSE operator is the highest, and the size of the operator is also the largest. Accordingly, after quantization of the DENSE operator is completed using the quantization method described herein, the size of the original model is compressed to ¼ of the original size. Similarly, after the text data is converted into a vector through a text converter and is then quantized using the quantization method described herein, a generated integer model may be stored in a device such as a CPU to perform hardware acceleration, and operations such as inference and prediction may be performed by reading it.

In an example of an NCF model when performing a task of constructing a recommendation system implementing a neural network, original user-item tuple data may be input to the NCF to obtain an item rank of a current user preference, and may go through cooperative filtering, and then an item that a user is most interested in according to a top-K ranking may be output as a recommended item. In an example of a movielens dataset, user-movie data may be input to the NCF model to calculate a similarity and a user preference. The calculation process may be completed mainly through a TAKE operator of the model and the size of the operator may be large, and thus a quantized model having only the size that is ¼ of the size of the original model may be obtained after quantization performed by the quantization method described herein. Inference may be performed by inputting data to the quantized model, and this process may increase a calculation speed by invoking a backend accelerator such as a CPU and a GPU. However, it may not significantly affect the recommendation accuracy, and the recommendation calculation time may rather be reduced. Thus, the quantization method described herein may play an important role in the execution of actual tasks by various types of neural network models.

The neural network model quantization apparatus 400 of the examples may convert a neural network model D_{FT} of which original accuracy is a floating-point number into an integer precision model D_{INT} to compress the memory space occupied by the original model in a situation where a loss of overall prediction accuracy is minimal and to improve the operation speed of the original model.

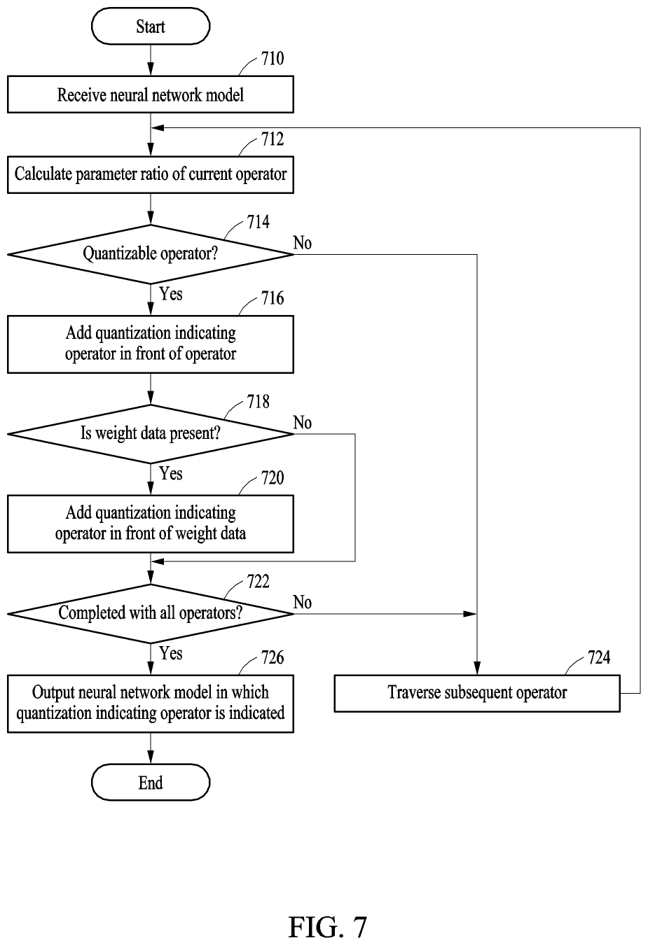

Hereinafter, detailed operations of the neural network model quantization apparatus 400 will be described with reference to FIGS. 7 through 9.

FIG. 7 illustrates an example of indicating quantization by a quantization indicator of an example neural network model quantization apparatus, in accordance with one or more embodiments. The operations in FIG. 7 may be performed in the sequence and manner as shown, although the order of some operations may be changed or some of the operations omitted without departing from the spirit and scope of the illustrative examples described. Many of the operations shown in FIG. 7 may be performed in parallel or concurrently. One or more blocks of FIG. 7, and combinations of the blocks, can be implemented by special purpose hardware-based computer that perform the specified functions, or combinations of special purpose hardware and computer instructions. In addition to the description of FIG. 7 below, the descriptions of FIGS. 1-6 are also applicable to FIG. 7, and are incorporated herein by reference. Thus, the above description may not be repeated here.

Referring to FIG. 7, when a neural network model D_{FP} is received in operation 710, the quantization indicator 420 (FIG. 4) of the neural network model quantization apparatus 400 may calculate a parameter ratio of a current operator in operation 712, and verify whether the current operator is a quantizable operator in operation 714. The quantizable operator may be an operator of which a ratio of parameters included in an operator of the neural network model to all parameters of the neural network model exceeds a threshold value, or an operator which belongs to a compute-intensive operator.

When the current operator is the quantizable operator as a result of the verifying in operation 714, the quantization indicator 420 may add a quantization indicating operator in front of the operator in operation 716.

The quantization indicator 420 may verify whether weight data is present in input data of the quantizable operator in operation 718.

When the weight data is present in the input data of the quantizable operator as a result of the verifying in operation 718, the quantization indicator 420 may add the quantization indicating operator in front of the weight data in operation 720.

The quantization indicator 420 may verify whether traversals of all the operators are completed in operation 722.

When the operator is not the quantizable operator as the result of the verifying in operation 714, or when the traversals of all the operators are not completed as a result of the verifying in operation 722, the quantization indicator 420 may traverse a subsequent operator in operation 724 and return to operation 712.

When the traversals of all the operators are completed as the result of the verifying in operation 722, the quantization indicator 420 may output a neural network model in which the quantization indicating operator is indicated in operation 726.

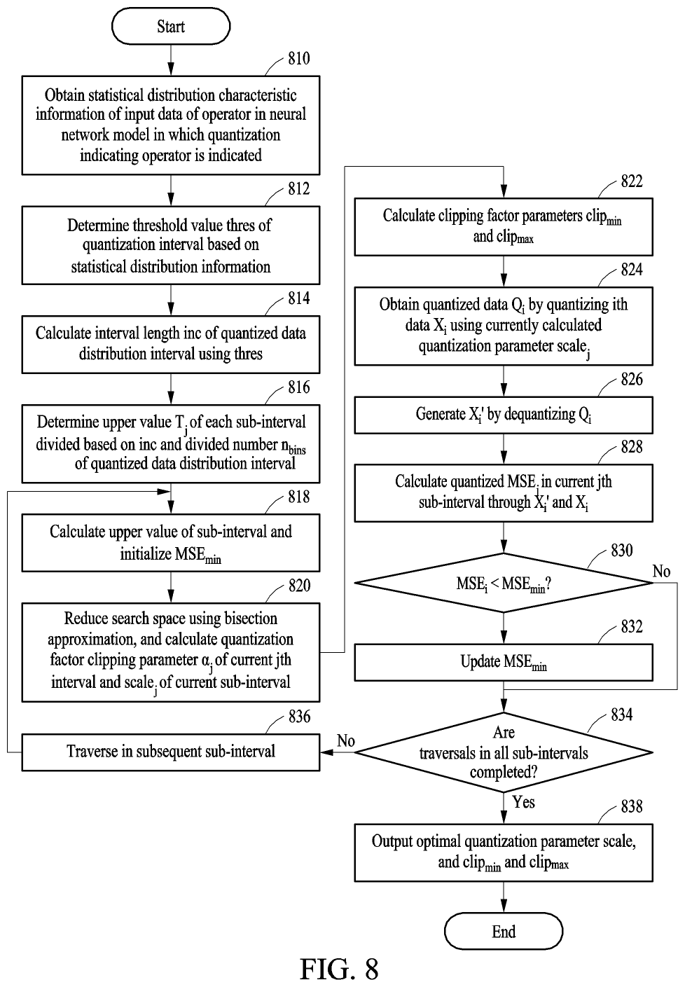

FIG. 8 illustrates an example of calculating a quantization parameter by a quantization parameter calculator of a neural network model quantization apparatus, in accordance with one or more embodiments. The operations in FIG. 8 may be performed in the sequence and manner as shown, although the order of some operations may be changed or some of the operations omitted without departing from the spirit and scope of the illustrative examples described. Many of the operations shown in FIG. 8 may be performed in parallel or concurrently. One or more blocks of FIG. 8, and combinations of the blocks, can be implemented by special purpose hardware-based computer that perform the specified functions, or combinations of special purpose hardware and computer instructions. In addition to the description of FIG. 7 below, the descriptions of FIGS. 1-7 are also applicable to FIG. 8, and are incorporated herein by reference. Thus, the above description may not be repeated here.

Referring to FIG. 8, the quantization parameter calculator 430 (FIG. 4) of the neural network model quantization apparatus 400 may obtain statistical distribution characteristic information of input data of each operator to be quantified through a verification dataset in an indicated model D_{FP} in which an indicating operator is present in operation 810, and determine a threshold value (thres) of a quantization interval based on the statistical distribution information in operation 812. In an example, thres may reflect therein quantized data distribution information, and ensure that a distribution of original data does not change during quantization.

Subsequently, the quantization parameter calculator 430 may calculate an interval length (inc) of the quantized data distribution interval using thres in operation 814, determine an upper value Tⱼ of each subinterval divided based on inc and the number n_{bins} of divided quantized data distribution intervals in operation 816, and calculate an upper value of a subinterval and initialize MSEₘᵢₙ in operation 818.

Subsequently, the quantization parameter calculator 430 may reduce a search space by using bisection approximation, and calculate a quantization factor clipping parameter αⱼ of a current jth interval and calculate scaleⱼ of the current subinterval in operation 820. The quantization parameter calculator 430 may calculate clipping factor parameters clipₘᵢₙ and clipₘₐₓ in operation 822, and obtain quantized data Qi by quantizing ith data Xᵢ using the currently calculated quantization parameter scaleⱼ in operation 824. The quantization parameter calculator 430 may generate Xᵢ′ by dequantizing Qᵢ in operation 826. The quantization parameter calculator 430 may calculate a quantized MSEⱼ in the current jth subinterval through Xᵢ′ and Xᵢ in operation 828.

The quantization parameter calculator 430 may then compare MSEⱼ and a current minimum MSEₘᵢₙ in operation 830. When MSEⱼ is less than MSEₘᵢₙ as a result of the comparing in operation 830, the quantization parameter calculator 430 may update MSEₘᵢₙ to MSEⱼ in operation 832.

The quantization parameter calculator 430 may then verify whether traversals are completed with all subintervals in operation 834.

When the traversals are not completed as a result of the verifying in operation 834, the quantization parameter calculator 430 may perform a traversal on a subsequent subinterval in operation 836, and return to operation 820.

When the traversals are completed as a result of the verifying in operation 834, the quantization parameter calculator 430 may output an optimal quantization parameter scale, and clipₘᵢₙ and clipₘₐₓ in operation 838.

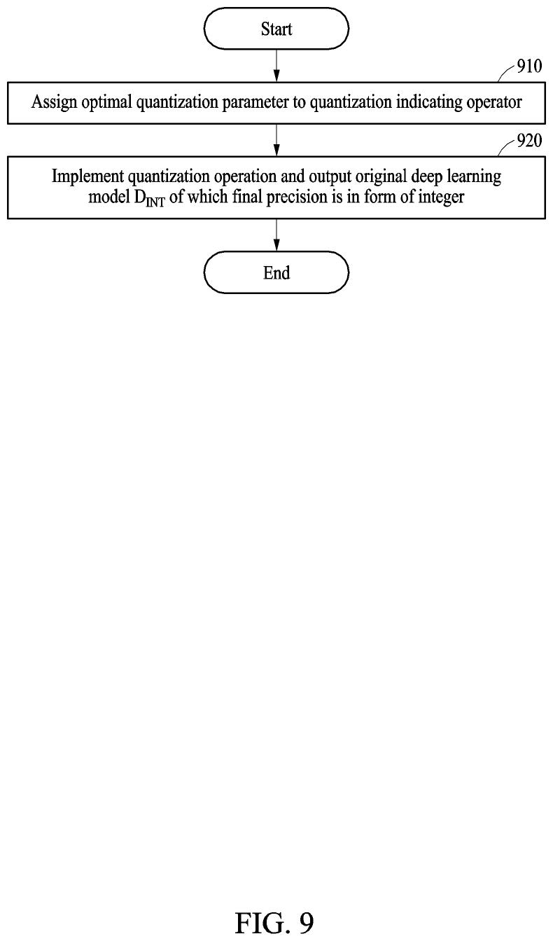

FIG. 9 illustrates an example of obtaining a neural network model having a quantized operator by a quantization implementor of a neural network model quantization apparatus, in accordance with one or more embodiments. The operations in FIG. 9 may be performed in the sequence and manner as shown, although the order of some operations may be changed or some of the operations omitted without departing from the spirit and scope of the illustrative examples described. Many of the operations shown in FIG. 9 may be performed in parallel or concurrently. One or more blocks of FIG. 9, and combinations of the blocks, can be implemented by special purpose hardware-based computer that perform the specified functions, or combinations of special purpose hardware and computer instructions. In addition to the description of FIG. 8 below, the descriptions of FIGS. 1-8 are also applicable to FIG. 9, and are incorporated herein by reference. Thus, the above description may not be repeated here.

Referring to FIG. 9, the quantization implementor 440 (FIG. 4) of the neural network model quantization apparatus 400 may assign an optimal quantization parameter to a quantization indicating operator in operation 910, and implement a quantization operation (e.g., rounding off, a form conversion, a multiplication, etc.) through basic hardware, and finally output an original deep learning model D_{INT} of which precision is in a form of an integer in operation 920.

According to example embodiments described herein, the neural network model quantization method and apparatus may calculate a quantization parameter corresponding to a quantizable operator based on bisection approximation, thereby finding the quantization parameter while effectively reducing a search space for the quantization parameter.

Additionally, under the condition that a precision loss is small, the neural network model quantization method and apparatus may reduce memory overhead by personalizing a clipping parameter value without storing an actual high-precision value of an original model, and compress the original size of the original depth model to approximately ¼. Thus, the neural network model quantization method and apparatus may solve an issue of existing clipping quantization methods not being able to achieve both accuracy and memory.

Additionally, the neural network model quantization method and apparatus may improve the operation speed of a model and add a quantization indicating operator when processing an operator to be quantized with a weight. Thus, the neural network model quantization method and apparatus may solve an existing issue of a probability-based quantization method having to predefine a weight data distribution.

Additionally, the neural network model quantization method and apparatus may traverse subintervals of a quantized data distribution using bisection approximation according to a reduced MSE monotonic change rule, and obtain a quantization parameter through the traversal, thereby reducing a search space of quantization parameters to be traversed and greatly improving the quantization speed.

Further, the neural network model quantization method and apparatus may use a method of determining different quantization parameters according to different data distribution characteristics. A personalization parameter obtained in this manner may not only combine local features of an original model, but also combine statistical characteristics of input data. Thus, when processing asymmetric or non-uniform data, the neural network model quantization method and apparatus may achieve a higher level of the quantization performance, compared to an existing entropy theory-based quantization method.

The neural network apparatuses, model, the neural network model quantization apparatus 400, the data acquirer 410, the quantization indicator 420, the quantization parameter calculator 430, and the quantization implementor 440, and other apparatuses, units, modules, devices, and other components described herein and with respect to FIGS. 1-9, are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods that perform the operations described in this application and illustrated in FIGS. 1-9 are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller, e.g., as respective operations of processor implemented methods. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computers using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A processor-implemented neural network model quantization method, the method comprising:
receiving a neural network model;
calculating a quantization parameter corresponding to an operator of the received neural network model to be quantized based on bisection approximation; and
quantizing the operator of the received neural network model to be quantized based on the calculated quantization parameter, and obtaining a neural network model having the quantized operator.

2. The method of claim 1, wherein the calculating of the quantization parameter corresponding to the operator to be quantized comprises:
receiving input data of the operator to be quantized by verifying the neural network model with a verification dataset; and
calculating a quantization parameter corresponding to a minimum mean squared error (MSE) of the input data of the operator to be quantized before and after quantization based on the input data of the operator to be quantized, by implementing bisection approximation.

3. The method of claim 2, wherein the calculating of the quantization parameter corresponding to the minimum MSE comprises:
performing dimensionality reduction on the input data of the operator to be quantized;
dividing the input data of the operator to be quantized after the performing of the dimensionality reduction into a plurality of data distribution intervals based on a statistical characteristic of the input data of the operator to be quantized after the dimensionality reduction, and obtaining an interval upper value array which is an array of upper values in each of the plurality of data distribution intervals; and
searching for the quantization parameter corresponding to the minimum MSE by bisectionally approximating an intermediate point between a start point and an end point of each of the data distribution intervals, by implementing bisection approximation.

4. The method of claim 3, wherein the quantization parameter comprises at least one of a clipping parameter, a quantization factor parameter, and a clipping factor parameter of each of the plurality of data distribution intervals.

5. The method of claim 3, wherein the searching for the quantization parameter comprises:
initializing the minimum MSE to be an initial MSE of each of the plurality of data distribution intervals when obtaining the interval upper value array each time for each of the plurality of data distribution intervals;
calculating an MSE of an approximate point of each of the plurality of data distribution intervals by bisectionally approximating the intermediate point between the start point and the end point of each of the plurality of data distribution intervals;
updating the minimum MSE by implementing the MSE of the approximate point when the MSE of the approximate point is less than the minimum MSE; and
outputting the quantization parameter corresponding to the minimum MSE when traversing the data distribution intervals,
wherein the initial MSE corresponds to a quantization parameter corresponding to an intermediate point between a start point and an end point of each of the data distribution intervals, and
wherein the MSE of the approximate point corresponds to a quantization parameter corresponding to an approximate point of each of the data distribution intervals.

6. The method of claim 1, wherein the operator of the received neural network model to be quantized is a quantizable operator comprised in the neural network model,
wherein the quantizable operator is an operator of which a ratio of parameters comprised in an operator of the neural network model to all parameters of the neural network model exceeds a threshold value, or an operator which belongs to a compute-intensive operator.

7. The method of claim 1, further comprising: inserting a quantization indicating operator in front of a quantizable operator of the neural network model and indicating the quantizable operator, before the calculating of the quantization parameter corresponding to the operator of the neural network model to be quantized.

8. The method of claim 7, wherein the indicating of the quantizable operator comprises:
verifying whether weight data is present in input data of the quantizable operator;
wherein when the weight data is not present in the input data of the quantizable operator, inserting the quantization indicating operator in front of the quantizable operator; and
wherein when the weight data is present in the input data of the quantizable operator, inserting the quantization indicating operator in front of the quantizable operator, and inserting the quantization indicating operator in front of the weight data to indicate whether the weight data needs to be quantized.

9. The method of claim 1, wherein the neural network model is a deep learning neural network model trained to perform at least one of image recognition, natural language processing, and recommendation system processing.

10. A non-transitory computer-readable storage medium storing instructions that, when executed by one or more processors, cause the one or more processors to perform the neural network model quantization method of claim 1.

11. A neural network model quantization apparatus, comprising:
a data acquirer configured to receive a neural network model;
a quantization parameter calculator configured to calculate a quantization parameter corresponding to an operator of the received neural network model to be quantized based on bisection approximation; and
a quantization implementor configured to quantize the operator to be quantized based on the quantization parameter, and obtain a neural network model having the quantized operator.

12. The apparatus of claim 11, wherein the quantization parameter calculator is configured to:
obtain input data of the operator to be quantized by verifying the neural network model using a verification dataset; and
calculate a quantization parameter corresponding to a minimum mean squared error (MSE) of the input data of the operator to be quantized before and after quantization based on the input data of the operator to be quantized, using bisection approximation.

13. The apparatus of claim 12, wherein, for the calculating of the quantization parameter corresponding to the minimum MSE, the quantization parameter calculator is configured to:
perform dimensionality reduction on the input data of the operator to be quantized;
divide the input data of the operator to be quantized after the performing of the dimensionality reduction into a plurality of data distribution intervals based on a statistical characteristic of the input data of the operator to be quantized after the dimensionality reduction, and obtain an interval upper value array which is an array of upper values in each of the plurality of data distribution intervals; and
search for the quantization parameter corresponding to the minimum MSE by bisectionally approximating an intermediate point between a start point and an end point of each of the data distribution intervals by implementing bisection approximation.

14. The apparatus of claim 13, wherein the quantization parameter comprises at least one of a clipping parameter, a quantization factor parameter, and a clipping factor parameter of each of the plurality of data distribution intervals.

15. The apparatus of claim 13, wherein, for the searching for the quantization parameter, the quantization parameter calculator is configured to:
initialize the minimum MSE to be an initial MSE of each of the plurality of data distribution intervals, when obtaining the interval upper value array each time for each of the plurality of data distribution intervals;
calculate an MSE of an approximate point of each of the plurality of data distribution intervals by bisectionally approximating the intermediate point between the start point and the end point of each of the plurality of data distribution intervals;
update the minimum MSE by implementing the MSE of the approximate point when the MSE of the approximate point is less than the minimum MSE; and
output the quantization parameter corresponding to the minimum MSE when traversing the data distribution intervals,
wherein the initial MSE corresponds to a quantization parameter corresponding to an intermediate point between a start point and an end point of each of the data distribution intervals, and
wherein the MSE of the approximate point corresponds to a quantization parameter corresponding to an approximate point of each of the data distribution intervals.

16. The apparatus of claim 11, wherein the operator of the received neural network model to be quantized is a quantizable operator comprised in the neural network model,
wherein the quantizable operator is an operator of which a ratio of parameters comprised in an operator of the neural network model to all parameters of the neural network model exceeds a threshold value, or an operator which belongs to a compute-intensive operator.

17. The apparatus of claim 11, further comprising:
a quantization indicator configured to indicate a quantizable operator of the neural network model by inserting a quantization indicating operator in front of the quantizable operator of the neural network model, and provide the quantizable operator to the quantization parameter calculator.

18. The apparatus of claim 17, wherein the quantization indicator is configured to:
determine whether weight data is present in input data of the quantizable operator;
wherein when the weight data is not present in the input data of the quantizable operator, insert the quantization indicating operator in front of the quantizable operator; and
wherein when the weight data is present in the input data of the quantizable operator, insert the quantization indicating operator in front of the quantizable operator and insert the quantization indicating operator in front of the weight data to indicate whether the weight data needs to be quantized.

19. The apparatus of claim 11, wherein the neural network model is a deep learning neural network model trained to perform at least one of image recognition, natural language processing, and recommendation system processing.
